(19) United States
(12) Patent Application Publication
(10) Pub. No.: US 2025/0266202 A1
(43) Pub. Date: Aug. 21, 2025

(54) INDUCTOR AND MANUFACTURING METHOD THEREOF

(71) Applicant: Kun Shan Mazo Tech Co., Ltd., Suzhou (CN)

(72) Inventors: Jinbing LI, Suzhou (CN); Yitai ZHAO, Suzhou (CN); Xunran WEI, Suzhou (CN); Yuxiang ZHUANG, Suzhou (CN); Zhijuan WANG, Suzhou (CN)

(21) Appl. No.: 18/761,355

(22) Filed: Jul. 2, 2024

(30) Foreign Application Priority Data
Feb. 18, 2024 (CN) 202410180005.0

(51) Int. Cl. H01F 27/02; H01F 1/20; H01F 27/29; H01F 41/00; H01F 41/064; H01F 41/26

(52) U.S. Cl. CPC H01F 27/022; H01F 1/20; H01F 27/292; H01F 41/005; H01F 41/064; H01F 41/26

(57) ABSTRACT

An inductor and a manufacturing method thereof. The inductor includes a coil, a magnetic base, and a magnetic covering layer, where the coil includes a conductor and an isolation layer coated on a surface of the conductor, the magnetic base is configured to fix the coil, the magnetic covering layer covers the coil located on the magnetic base, and an equivalent particle size of metal particles in the magnetic covering layer is less than or equal to twice the thickness of the isolation layer. In the present disclosure, the magnetic covering layer of the inductor is made of a soft magnetic metal material, and the equivalent particle size of the metal particles in the soft magnetic metal material is less than or equal to twice the thickness of the isolation layer of the coil, such that a short circuit percentage caused by powder piercing the coil can be reduced.

### CROSS-REFERENCE TO RELATED APPLICATIONS

The present application is based upon and claims priority to Chinese patent application No. 202410180005.0, filed on Feb. 18, 2024, the entire content of which is incorporated herein by reference.

### TECHNICAL FIELD

The present disclosure relates to the technical field of inductors, and specifically to an inductor and a manufacturing method thereof.

### BACKGROUND

The inductor is an electronic component, and a device for energy storage and current regulation. It operates based on the principle of electromagnetic induction and stores electrical energy by generating a magnetic field in a conductor.

An inductor is composed of one or more coils which are usually made of wires wound around a magnetic core. When a current passes through a coil, a magnetic field is generated around. This magnetic field will cause the current inside the coil to change, resulting in an electromotive force, which will hinder the current change according to Faraday's law of electromagnetic induction. Therefore, the inductor may resist the current change and play a current stabilizing role in a circuit.

The inductor is a device for energy storage and current regulation, and operates based on the principle of electromagnetic induction. It plays a role in stabilizing current and filtering noise in the circuit, and is widely used in various electronic systems and circuits.

When the inductor is short-circuited, the resistance between two terminals in the inductor is almost zero, causing the current to flow in an internal circuit of the inductor instead of flowing to an external circuit. The short circuit problem caused by powder piercing the coil may cause damage to the inductor and the circuit.

### SUMMARY

To solve the above technical problems, the present disclosure provides an inductor, including a coil, a magnetic base, and a magnetic covering layer, where the coil includes a conductor and an isolation layer coated on a surface of the conductor, the magnetic base is configured to fix the coil, the magnetic covering layer covers the coil located on the magnetic base, and an equivalent particle size of metal particles in the magnetic covering layer is less than or equal to twice the thickness of the isolation layer.

Preferably, the thickness of the isolation layer is T, and 0.002 mm≤T≤0.5 mm.

Preferably, a particle size distribution of the equivalent particle size of the metal particles in the magnetic covering layer is X, and when a cumulative percentage of the particle size distribution reaches X %, a corresponding particle size is Dx, and Dx≤2*T, in which 0.004 mm≤Dx≤1 mm.

Preferably, 50≤X≤100, preferably, 90≤X≤100.

Preferably, the magnetic covering layer includes a soft magnetic metal material.

Preferably, the magnetic base includes a plane layer and at least one protrusion layer, where the protrusion layer is configured to wrap the coil, and gaps are formed on a side of the plane layer along a length direction and are used for pins to pass through.

Preferably, the pins formed at two ends of the coil are configured to be connected to terminals, and the terminals are attached to a lower surface of the magnetic base.

Preferably, the number of the gaps is consistent with the number of the terminals.

A manufacturing method for an inductor includes the following specific steps:
S1: preparing a magnetic base, in which a mold is filled with powder, press forming is performed to obtain a blank, and the blank undergoes heat curing to obtain the magnetic base;
S2: assembling a coil and the magnetic base, in which the coil is wound around the magnetic base, and pins of the coil are folded from one side to the other side of the magnetic base;
S3: encapsulating a magnetic covering layer, in which the assembled coil and magnetic base are placed into the mold, pressing is performed after magnetic powder is filled, and a pressed encapsulated blank undergoes heat curing to obtain a semi-finished inductor; and
S4: performing spraying, laser processing, and electroplating on the semi-finished inductor, in which the semi-finished inductor is sprayed with insulating paint, then the paint on the coil at the bottom of the magnetic base is removed by means of a laser process, and electroplating is performed to form terminals, so as to obtain the inductor.

Preferably, the particle size of the magnetic powder is less than or equal than twice the thickness of an isolation layer of the coil.

The present disclosure has the following technical effects and advantages:

In the present disclosure, the magnetic covering layer of the inductor is made of the soft magnetic metal material, and the equivalent particle size of the metal particles in the soft magnetic metal material is less than or equal to twice the thickness of the isolation layer of the coil, such that a short circuit percentage caused by the powder piercing the coil can be reduced.

### BRIEF DESCRIPTION OF THE DRAWINGS

FIG. 1 is a schematic structural diagram of an inductor provided by an embodiment of the present application;

FIG. 2 is a schematic structural diagram of wrapping of a coil in an inductor provided by an embodiment of the present application;

FIG. 3 is a front view of a magnetic base in an inductor provided by an embodiment of the present application;

FIG. 4 is a top view of a magnetic base in an inductor provided by an embodiment of the present application;

FIG. 5 is a schematic structural diagram of a coil in an inductor provided by an embodiment of the present application; and

FIG. 6 is a schematic diagram of particles in a soft magnetic metal material of a magnetic covering layer of an inductor provided by an embodiment of the present application.

In the drawings: 1. coil; 11. conductor; 12. isolation layer; 2. magnetic base; 21. plane layer; 22. gap; 23. protrusion layer; 3. magnetic covering layer; 4. terminal; and 5. pin.

### DESCRIPTION OF THE EMBODIMENTS

The present disclosure is further described in detail below in conjunction with the accompanying drawings and specific embodiments. The embodiments of the present disclosure are provided for examples and description, and are not exhaustive or limit the present disclosure to the disclosed form. Many modifications and variations are obvious to those of ordinary skill in the art. The embodiments are selected and described to better illustrate the principles and practical applications of the present disclosure, and to enable those of ordinary skill in the art to understand the present disclosure and thus design various embodiments with various modifications suitable for specific purposes.

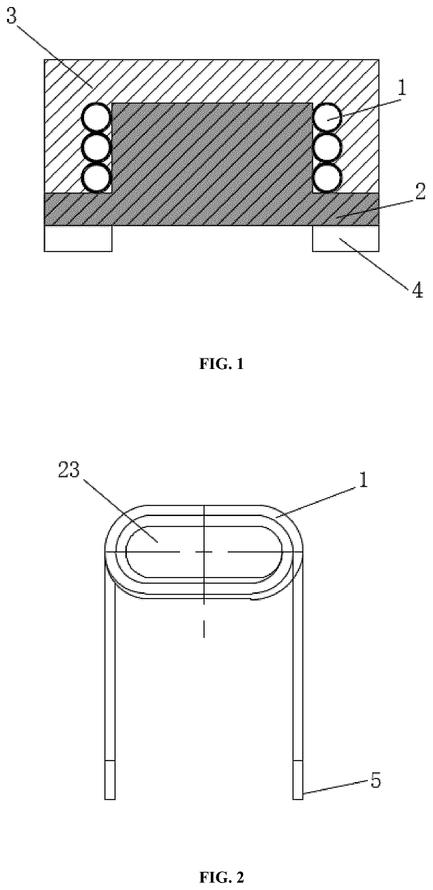

Referring to FIGS. 1 and 2, in this embodiment, provided is an inductor, including: a coil 1 and a magnetic base 3, where the magnetic base 3 is configured to fix the coil 1, pins 5 formed at two ends of the coil 1 are configured to be connected to terminals 4, and the terminals 4 are attached to a lower surface of the magnetic base 2; and a magnetic covering layer 3, where the magnetic covering layer 3 is located on an upper surface of the magnetic base 2 and covers the coil 1 located on the magnetic base 3.

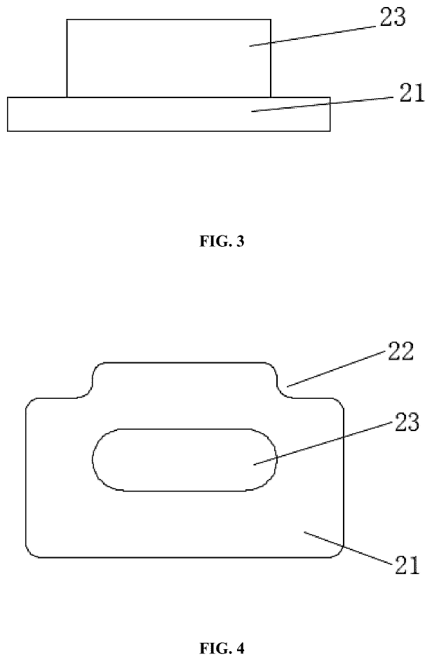

In this embodiment, referring to FIGS. 3 and 4, the magnetic base 2 includes a plane layer 21 and at least one protrusion layer 22, where the protrusion layer 22 is configured to wrap the coil 1, gaps 22 are formed on a side of the plane layer 21 along a length direction, the gaps 22 are used for the pins 5 to pass through, and the number of the gaps 22 is consistent with the number of the terminals 4.

Specifically, a section of the coil 1 is not limited to being circular, and may also be rectangular, polygonal, or irregularly shaped. The coil 1 is spirally wound around the protrusion layer 22 to one or more layers of coils 1. The two pins 5 of the coil 1 are connected to the terminals 4 through the gaps 22, and then the magnetic base 2 is coated with the magnetic covering layer 3 to cover the coil 1. When a current passes through the coil 1, a magnetic field is generated. The magnetic field interacts with the magnetic base 2 to form an inductive effect.

As shown in FIG. 5, the coil 1 includes a conductor 11 and an isolation layer 12, where the isolation layer 2 is coated on a surface of the conductor 11, the conductor 11 is connected to the pin 5, and the thickness of the isolation layer 12 is T.

0.002 mm≤T≤0.5 mm, preferably, 0.05 mm≤T≤0.2 mm.

Further, the isolation layer 12 is made of an insulating flexible polymer material, where the insulating flexible polymer material is a material such as polyamide, polyimide, or polyether, and the material of the isolation layer 12 has no effect on short-circuit verification.

Further, the magnetic base 2 is made of metal soft magnetic powder by means of die casting, where a material of the metal soft magnetic powder includes but is not limited to silicon steel, nickel-iron alloy, iron-nickel alloy, and iron-aluminum alloy, and the metal soft magnetic powder is a type of metal magnetic material and has the characteristics of high magnetization degree, stable magnetic properties, high temperature resistance, wide temperature range, corrosion resistance, etc.

The metal soft magnetic powder has high corrosion resistance and deformation resistance, is better than ordinary silicon iron and water iron wire materials in physical properties, and has stable magnetic properties. In addition, it has high stability and mechanical stability, which makes the magnetic properties of the product more stable and reliable.

Further, two terminals 4 are provided, in which one terminal is an input terminal, and the other terminal is an output terminal. The two terminals are configured to connect the inductor to other components in a circuit. The input terminal is a current input terminal which receives a current signal from the circuit, and the output terminal is a current output terminal which outputs a current signal passing through the inductor.

Further, two pins 5 are provided, in which one pin is an input pin, and the other pin is an output pin. The input pin is the current input terminal of the inductor which receives the current signal from the circuit, and the output pin is the current output terminal of the inductor which outputs the current signal passing through the inductor.

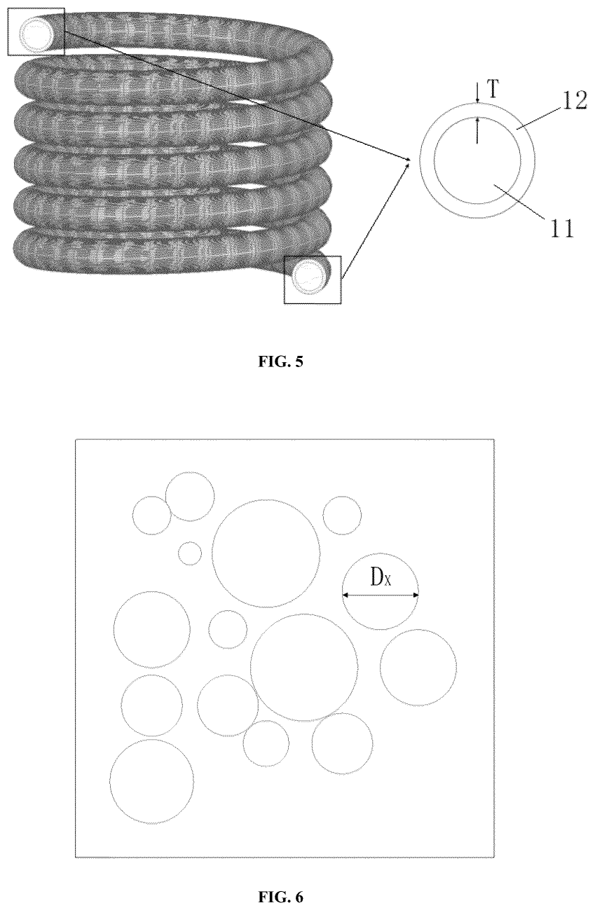

In this embodiment, as shown in FIG. 6, the magnetic covering layer includes a soft magnetic metal material, where the magnetic metal material has a risk of piercing the isolation layer of the coil, and the soft magnetic metal material is selected from one or a combination of two or more of iron-based powder, iron-based amorphous powder, iron-silicon-aluminum alloy powder, iron-silicon alloy powder, iron-nickel alloy powder, and nanocrystal alloy powder.

Specifically, a particle size distribution of an equivalent particle size of metal particles in the soft magnetic metal material is X, and when a cumulative percentage of the particle size distribution reaches X %, a corresponding particle size is Dx, and Dx≤2*T, in which 0.004 mm≤Dx≤1 mm, preferably, 0.1 mm≤Dx≤0.4 mm.

Further, 50≤X≤100, preferably, 90≤X≤100.

The present application is further described in detail below in conjunction with embodiments.

### Embodiment 1

The particle size D70 of the powder of the magnetic covering layer is equal to 0.035 mm, the thickness T of the isolation layer coated on the surface of the conductor of the coil is equal to 0.02 mm, and a short circuit percentage of the product after a 200 V waveform test is 2%.

### Embodiment 2

The particle size D90 of the powder of the magnetic covering layer is equal to 0.038 mm, the thickness T of the isolation layer coated on the surface of the conductor of the coil is equal to 0.017 mm, and the short circuit percentage of the product after a 200 V waveform test is 1%.

### Embodiment 3

The particle size D97 of the powder of the magnetic covering layer is equal to 0.038 mm, the thickness T of the isolation layer coated on the surface of the conductor of the coil is equal to 0.017 mm, and the short circuit percentage of the product after a 200 V waveform test is 0.5%.

### Embodiment 4

The particle size D97 of the powder of the magnetic covering layer is equal to 0.030 mm, the thickness T of the isolation layer coated on the surface of the conductor of the coil is equal to 0.02 mm, and the short circuit percentage of the product after a 200 V waveform test is 0.04%.

### Embodiment 5

The particle size D99 of the powder of the magnetic covering layer is equal to 0.032 mm, the thickness T of the isolation layer coated on the surface of the conductor of the coil is equal to 0.02 mm, and the short circuit percentage of the product after a 200 V waveform test is 0%.

### Comparative Example 1

The particle size D70 of the powder of the magnetic covering layer is equal to 0.035 mm, the thickness T of the isolation layer coated on the surface of the conductor of the coil is equal to 0.01 mm, and a short circuit percentage of the product after a 200 V waveform test is 6.4%.

TABLE 1
Test results:

| | Cumulative | | Thickness | Short |
|---|---|---|---|---|
| Embodiment/ | percentage (%) | Particle | T (mm) of | circuit |
| comparative | of particle size | size Dx (mm) | isolation | percentage |
| example | distribution | of powder | layer | (%) |
| Embodiment 1 | 70 | 0.035 | 0.02 | 2 |
| Embodiment 2 | 90 | 0.038 | 0.019 | 1 |
| Embodiment 3 | 97 | 0.038 | 0.019 | 0.5 |
| Embodiment 4 | 97 | 0.030 | 0.02 | 0.04 |
| Embodiment 5 | 99 | 0.032 | 0.02 | 0 |
| Comparative | 70 | 0.035 | 0.01 | 6.4 |
| example 1 | | | | |

The total number of samples is 18,720, and the short circuit percentage=the number of samples with poor waveforms/the total number of the samples.

In the waveform test, during measurement, a same pulse in measurement of the standard inductor is applied to the measured inductor through capacitor discharge, a voltage attenuation waveform corresponding to the discharge pulse is responded due to the existence of an inductance of the inductor and a Q value, some features of the attenuation waveform are compared, the inter-turn and inter-layer short circuit of the inductor and the difference between the number of turns and the magnetic material may be detected, and when a waveform area of the measured inductor is less than 80% of an area of the standard inductor by applying a 200 V voltage pulse, that is, the measured inductor has a poor waveform, it is determined that the inductor is short-circuited.

It can be seen from Embodiment 1, Comparative example 1, and Table 1 that

The particle size D70 of the powder is less than twice the thickness (2T=0.04 mm) of the isolation layer in Embodiment 1, the particle size D70 of the powder is greater than twice the thickness (2T=0.02 mm) of the isolation layer in Comparative example 1, and when the short circuit percentage after the 200 V waveform test is reduced from 6.4% in Comparative example 1 to 2% in Embodiment 1, it indicates that the short circuit percentage caused by the powder piercing the coil can be reduced when the particle size of the powder is less than twice the thickness of the isolation layer.

It can be seen from Embodiment 2, Embodiment 3, and Table 1 that

In Embodiment 2 and Embodiment 3, the particle sizes of the powder and the thicknesses of the isolation layers are both the same, and when the cumulative percentage of the particle size distribution increases, the short circuit percentage is reduced.

It can be seen from Embodiments 1 to 5 and Table 1 that

When the particle size of the powder is less than twice the thickness of the isolation layer, the short circuit percentage caused by the powder piercing the coil is greatly reduced.

In another embodiment, further provided is a manufacturing method for an inductor, including the following specific steps:
S1: preparing a magnetic base, in which a mold is filled with powder, press forming is performed to obtain a blank, and the blank undergoes heat curing to obtain the magnetic base;
S2: assembling a coil and the magnetic base, in which the coil is wound around the magnetic base, and pins of the coil are folded from one side to the other side of the magnetic base;
S3: encapsulating a magnetic covering layer, in which the assembled coil and magnetic base are placed into the mold, pressing is performed after magnetic powder is filled, and a pressed encapsulated blank undergoes heat curing to obtain a semi-finished inductor; and
S4: performing spraying, laser processing, and electroplating on the semi-finished inductor, in which the semi-finished inductor is sprayed with insulating paint, then the paint on the coil at the bottom of the magnetic base is removed by means of a laser process, and electroplating is performed to form terminals, so as to obtain the inductor.

In step S1, the powder is metal soft magnetic powder, the prepared magnetic base includes a plane layer and a protrusion layer, and gaps are formed on the plane layer.

In step S2, the pins of the coil are folded from one side of the plane layer to the other side of the plane layer of the magnetic base.

In step S3, the particle size of the magnetic powder is selected to be less than or equal than twice the thickness of an isolation layer of the coil.

The magnetic covering layer is made of a soft magnetic metal material, and an equivalent particle size of metal particles in the soft magnetic metal material is less than or equal to twice the thickness of the isolation layer of the coil.

Preferably, a particle size distribution of the equivalent particle size of the metal particles in the magnetic covering layer is X, and when a cumulative percentage of the particle size distribution reaches X %, a corresponding particle size is Dx, and Dx≤2*T, in which T is the thickness of the isolation layer of the coil in the inductor.

Further, the magnetic metal material is selected from one or a combination of two or more of iron-based powder, iron-based amorphous powder, iron-silicon-aluminum alloy powder, iron-silicon alloy powder, iron-nickel alloy powder, and nanocrystal alloy powder.

Further, 50≤X≤100, preferably, 90≤X≤100, and 0.002 mm≤T≤0.5 mm, preferably, 0.05 mm≤T≤0.2 mm.

When the particle size of the powder is less than twice the thickness of the isolation layer, the short circuit percentage caused by the powder piercing the coil can be reduced.

Apparently, the described embodiments are merely part rather than all of the embodiments of the present disclosure. All other embodiments obtained by those of ordinary skill in the art and related fields based on the embodiments of the present disclosure without creative efforts shall fall within the scope of protection of the present disclosure. The structures, apparatuses and methods of operation not specifically described and explained in the present disclosure are implemented according to conventional means in the art, unless specifically described and limited.

What is claimed is:

1. An inductor, comprising a coil, a magnetic base, and a magnetic covering layer, the coil comprising a conductor and an isolation layer coated on a surface of the conductor, the magnetic base being configured to fix the coil, the magnetic covering layer covering the coil located on the magnetic base, wherein
an equivalent particle size of metal particles in the magnetic covering layer is less than or equal to twice the thickness of the isolation layer.

2. The inductor according to claim 1, wherein the thickness of the isolation layer is T, and 0.002 mm≤T≤0.5 mm.

3. The inductor according to claim 1, wherein a particle size distribution of the equivalent particle size of the metal particles in the magnetic covering layer is X, and when a cumulative percentage of the particle size distribution reaches X %, a corresponding particle size is Dx, and Dx≤2*T, in which 0.004 mm≤Dx≤1 mm.

4. The inductor according to claim 3, wherein 50≤X≤100, preferably, 90≤X≤100.

5. The inductor according to claim 1, wherein the magnetic covering layer comprises a soft magnetic metal material.

6. The inductor according to claim 1, wherein the magnetic base comprises a plane layer and at least one protrusion layer, the protrusion layer is configured to wrap the coil, and gaps are formed on a side of the plane layer along a length direction and are used for pins to pass through.

7. The inductor according to claim 6, wherein the pins formed at two ends of the coil are configured to be connected to terminals, and the terminals are attached to a lower surface of the magnetic base.

8. The inductor according to claim 7, wherein the number of the gaps is consistent with the number of the terminals.

9. A manufacturing method for an inductor, comprising the following specific steps:
S1: preparing a magnetic base, in which a mold is filled with powder, press forming is performed to obtain a blank, and the blank undergoes heat curing to obtain the magnetic base;
S2: assembling a coil and the magnetic base, in which the coil is wound around the magnetic base, and pins of the coil are folded from one side to the other side of the magnetic base;
S3: encapsulating a magnetic covering layer, in which the assembled coil and magnetic base are placed into the mold, pressing is performed after magnetic powder is filled, and a pressed encapsulated blank undergoes heat curing to obtain a semi-finished inductor; and
S4: performing spraying, laser processing, and electroplating on the semi-finished inductor, in which the semi-finished inductor is sprayed with insulating paint, then the paint on the coil at the bottom of the magnetic base is removed by means of a laser process, and electroplating is performed to form terminals, so as to obtain the inductor.

10. The manufacturing method for an inductor according to claim 9, wherein the particle size of the magnetic powder is less than or equal than twice the thickness of an isolation layer of the coil.
